(19) United States
(12) Patent Application Publication
(10) Pub. No.: US 2007/0038804 A1
(43) Pub. Date: Feb. 15, 2007

(54) Testmode and test method for increased stress duty cycles during burn in

(76) Inventors: Klaus Nierle, Essex Junction, VT (US); Martin Versen, Munchen (DE)

Correspondence Address: PATTERSON & SHERIDAN, LLP;Gero McClellan / Infineon / Qimonda, 3040 POST OAK BLVD.,, SUITE 1500, HOUSTON, TX, 77056, US

(21) Appl. No.: 11/203,338

(22) Filed: Aug. 12, 2005

(51) Int. Cl. G06F 13/28

(52) U.S. Cl. 711/106

(57) ABSTRACT

Embodiments of the invention provide a method, apparatus, and system for operating a memory device. In one embodiment, an inverted refresh command is received. In response to receiving the inverted refresh command, an all bank precharge command is issued. After the all bank precharge command is issued, an all bank activate command is issued, causing wordlines identified by a row address counter to be activated. The identified wordlines are maintained in activated state until a subsequent inverted refresh command is received.

### BACKGROUND OF THE INVENTION

1. Field of the Invention

The invention generally relates to methods and apparatuses for testing a memory device. More specifically, the invention relates to increasing the stress placed on a memory device during testing of the memory device.

2. Description of the Related Art

Many modern digital devices typically contain a semiconductor memory (e.g., a dynamic random access memory, DRAM) which may be used to store information used by the digital device. To ensure that a memory operates correctly when placed in a digital device, the memory may be subjected to rigorous testing. As an example, the memory may undergo a test referred to as a burn-in.

A burn-in typically involves applying a high temperature to a memory device (typically using a device referred to as a burn-in oven) along with elevated voltages. The burn-in is typically intended to apply stress to the memory device in order to detect latent defects in the memory device (also called early life defects).

During a burn-in, the memory device may be further stressed by issuing commands to the memory device. The commands are typically issued to increase the stress placed on circuits in the memory device (e.g., the transistors in the memory device and the memory cells in the memory device). The amount of stress placed on a given circuit in the memory device is measured using a value called the stress time. The stress time refers to the sum of all active times of a transistor during which an electric field is applied across the transistor (e.g., between the transistor gate and channel). Generally, to improve the efficiency of the burn-in in detecting defects in the memory device, the amount of stress time may be increased. However, at the same time, the manufacturer may desire to get the memory device product to market as quickly as possible, and may therefore desire that the latency of the burn-in process (e.g., the time spent testing the memory device) be decreased. Thus, there is typically a desire to increase the efficiency of burn-in tests such that the device is stressed to the maximum acceptable extent in the minimum amount of time.

A wordline is a line used to access a row of memory cells. The memory cells in each memory device may be divided into multiple sections, referred to as banks, and each bank may contain multiple wordlines. When a voltage is applied to a wordline, the transistors used to access each memory cell in the wordline (referred to as access transistors) may be stressed. Some commands issued during burn-in may be designed to stress wordlines within the memory device.

During burn-in, for example, a CBR command may be issued to the memory device to stress wordlines within the memory device by performing a refresh. A refresh is an operation which restores the charges in memory cells which are used to store information. The CBR command is typically issued to the memory device by pulling a first input line on the memory device (the Column Address Strobe line, or /CAS) to a low logic value and subsequently pulling a second input line on the memory device (the Row Address Strobe line, or /RAS) to a low logic value (/CAS Before /RAS, thus the name, CBR).

FIG. 1A is a timing diagram depicting a series of CBR commands issued to a memory device during burn-in. In performing the refresh, the CBR command may issue an all bank activate command (ACT) followed by an all bank precharge command (PREA) according to a refresh timer. Thus, at time T₁, when a first CBR command is received by the memory device, an ACT command may be issued to memory banks in the memory device. The ACT command may drive a wordline voltage V_{WL} in the memory device to a high voltage V_{PP}, thereby stressing the access transistors in the wordline. The wordline voltage V_{WL} may be held at V_{PP} for time T_{RAS} (the row access time, from T₁ to T₂), allowing the memory cells in the wordline sufficient time to fully recharge.

At time T₂, a PREA command may be issued to the memory device. The PREA command may cause the wordline voltage V_{WL} for each of the wordlines to be driven to a low voltage (e.g., 0 volts). Driving the wordline voltage to a low voltage may electrically disconnect the output lines connected to each memory cell (referred to as bitlines), allowing the bitlines to be precharged for the next refresh operation. The wordline voltage may remain at the low voltage for time T_{RP} (the row precharge time, from T₁ to T₃), allowing the bitlines to fully precharge. At time T₃, another CBR command may be received by the memory device, causing another ACT command to be issued to the memory banks and driving V_{WL} back to V_{PP}.

The total time used to issue a CBR command is T_{RAS}+T_{RP}. The time T_{RAS}+T_{RP} is referred to as the read cycle time, T_{RC} (from time T₁ to T₃). As previously described, the wordline transistors may be stressed while the ACT command is being issued to the wordlines (during time T_{RAS}). The percentage of time a wordline is stressed during each command cycle (T_{RAS}/T_{RC}) is referred to as the duty cycle. As depicted in FIG. 1A, the duty cycle for a series of CBR commands may, as an example, be around 35%.

In some cases, in order to increase the stress time and duty cycle during burn-in (and thereby reduce overall burn-in time), commands other than the CBR command may be issued to the memory device. For instance, a series of separate ACT and PREA commands may be issued to the memory device. FIG. 1B is a timing diagram depicting a series of all bank activate and all bank precharge commands issued to a memory device during burn-in. Because the refresh timer utilized by the CBR command may not be utilized when issuing separate ACT and PREA commands, the duty cycle for the wordline voltage V_{WL} may be increased to 50%.

However, in some cases, a higher duty cycle than 50% may be desired in order to further reduce the time necessary to perform the burn-in. Accordingly, what is needed are methods and apparatuses for increasing stress duty cycles during burn-in.

### SUMMARY OF THE INVENTION

Embodiments of the invention provide a method, apparatus, and system for operating a memory device. In one embodiment, an inverted refresh command is received. In response to receiving the inverted refresh command, an all bank precharge command is issued. After the all bank precharge command is issued, an all bank activate command is issued, causing wordlines identified by a row address counter to be activated. The identified wordlines are maintained in activated state until a subsequent inverted refresh command is received.

One embodiment of the invention provides a memory device including one or more memory banks, wherein each memory bank includes one or more wordlines, memory bank control circuitry, a row address counter, and control circuitry. The control circuitry is configured to receive an inverted refresh command and issue an all bank precharge command to the memory bank control circuitry in response to receiving the inverted refresh command. The control circuitry is further configured to issue an all bank activate command to the memory bank control circuitry after issuing the all bank precharge command, causing wordlines identified by the row address counter to be activated. The memory bank control circuitry maintains the identified wordlines in activated state until a subsequent inverted refresh command is received.

One embodiment of the invention provides a memory device which includes means for storing, including one or more wordlines, means for addressing, and means for controlling. The means for controlling is configured to receive an inverted refresh command and issue a precharge command to the means for storing in response to receiving the inverted refresh command. The means for controlling is further configured to issue an activate command to the means for storing after issuing the precharge command, causing wordlines identified by means for addressing to be activated. The identified wordlines are maintained in an activated state until a subsequent inverted refresh command is received.

One embodiment of the invention provides a system which includes a tester and a memory device. The tester is configured to issue a plurality of inverted refresh commands. The memory device is configured to receive the plurality of inverted refresh commands from the tester, and, in response to receiving each of the plurality of inverted refresh commands issue an all bank precharge command. The memory device is further configured to issue an all bank activate command after issuing the all bank precharge command, causing wordlines identified by a row address counter to be activated and maintained in an activated state until a subsequent inverted refresh command is received from the tester. The memory device is further configured to increment the row address counter.

One embodiment of the invention provides a method for testing a memory device. In one embodiment, the method includes sending a first inverted refresh command to the memory device, wherein, in response to receiving the inverted refresh command, the memory device triggers a first all bank precharge command, wherein the all bank precharge command is automatically terminated by a first all bank activate also triggered by the memory device. The method also includes sending a second inverted refresh command to the memory device, wherein the second inverted refresh command triggers a second all bank precharge command, wherein the second all bank precharge command deactivates one or more wordlines in the memory device activated by the first all bank activate command.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B are timing diagrams depicting various command sequences issued to a memory device during a burn-in of the memory device.

FIG. 2 is a block diagram depicting a testing device and memory device according to one embodiment of the invention.

FIG. 3 is a block diagram depicting a memory device which utilizes an inverted refresh command according to one embodiment of the invention.

FIG. 4 is a flow diagram depicting a method for increasing the stress duty cycle of a wordline during burn-in according to one embodiment of the invention.

FIG. 5 is a timing diagram depicting inverted refresh commands issued to a memory device according to one embodiment of the invention.

### DETAILED DESCRIPTION OF THE PREFERRED EMBODIMENT

Embodiments of the invention generally provide methods and apparatus for increasing the stress duty cycle of wordlines in a memory device during burn-in. In one embodiment, an inverted refresh command (/CBR) is provided. The inverted refresh command causes an all bank precharge command (PREA) to be issued to the memory device followed by an all bank activate command (ACT). In one embodiment, the wordline is not precharged after the inverted refresh command but rather maintained in an active state. By maintaining the wordlines in an active state, the stress time and duty cycle of the wordlines is increased.

While embodiments of the invention are described below with respect to certain command names (CBR, /CBR, PREA, ACT, etc.), such command names are exemplary and not limiting. Such commands may be issued to the memory device and within the memory device in any appropriate manner.

While described below with respect to a tester applying commands to a memory device during a burn-in, such commands may be issued to the memory device by any device (e.g., a tester, an electronic device in which the memory device is placed, by the memory device itself during a self-test, or by any other device). Further, in some cases, such commands may be issued to the memory device at any time, including during times where the device is not undergoing a burn-in. Such commands may be issued by a tester using a probe card while the memory device is still part of a wafer, by a tester after the memory device has been separated from the wafer, and by an electronic device after the memory device has been installed in the electronic device.

### An Exemplary Memory Device

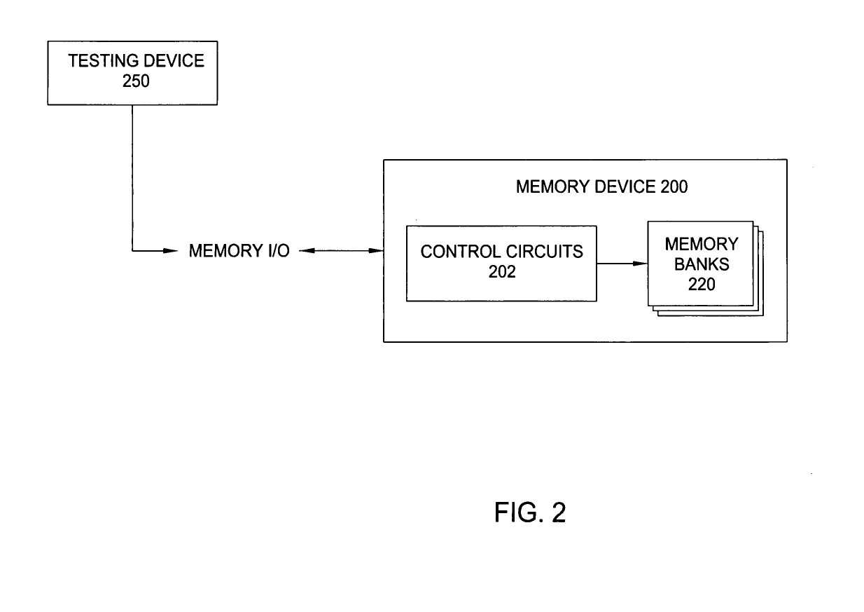

FIG. 2 is a block diagram depicting a memory device 200 and a testing device 250 according to one embodiment of the invention. The memory device 200 may contain control circuits 202 used to access one or more memory banks 220 of the memory device 200. In one embodiment, the testing device 250 may use the input/output (I/O) lines of the memory device 200 to issue commands to the memory device 200. The commands may include commands ordinarily issued to the memory device as well as commands used specially for testing.

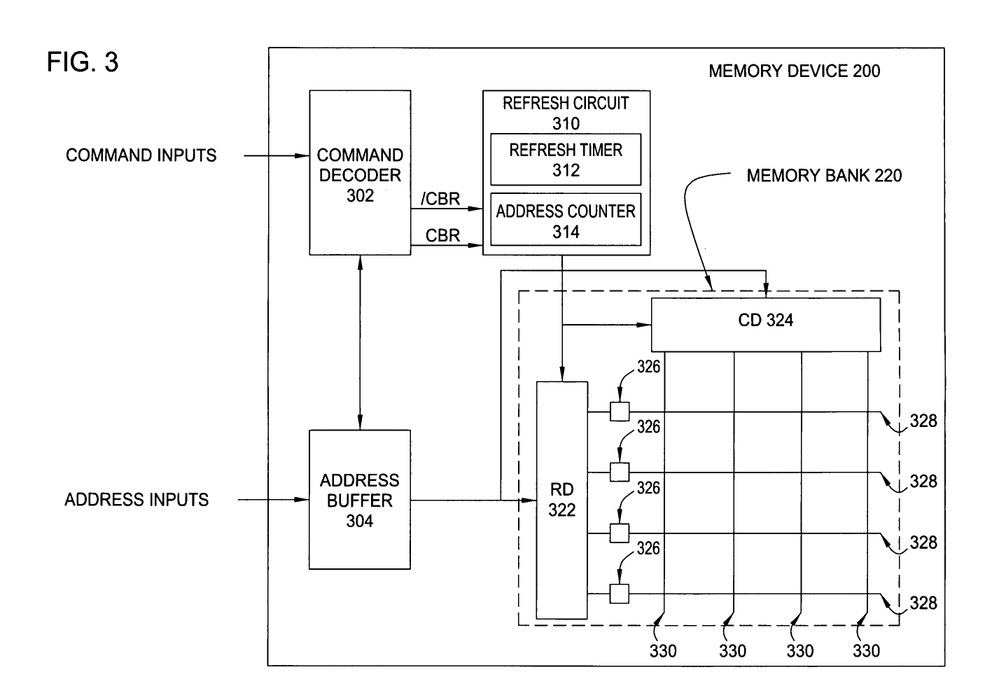

FIG. 3 is a block diagram depicting the memory device 200 according to one embodiment of the invention. The memory device 200 may include address inputs and command inputs. The address inputs may be received by an address buffer 304 and the command inputs may be receive by a command decoder 302. The address inputs may be used by a row decoder 322 and column decoder 324 to access memory cells in a memory bank 220. In some cases, multiple memory banks 220 may be accessed using a single row decoder 322 and column decoder 324.

When a given row of memory cells in the memory bank 220 is accessed, the row decoder may activate a wordline driver 326 which drives the wordline 328 for that row of memory. The column decoder 220 may select columns 330 of the memory bank 220 to be accessed. Other circuitry such as sense amps, output buffers, data strobe circuits, etc. (not depicted) may also be used to access and output data from the memory bank 220.

In one embodiment, the memory device 200 may also have a refresh circuit 310. The refresh circuit may contain a refresh timer 312 (optionally, a row access timer, or T_{RAS} timer, may be used) and an address counter 314. As described below, in one embodiment, the refresh circuit 310 may be used to implement the CBR and inverted CBR (/CBR) commands.

### The CBR Command

An exemplary implementation of the CBR command is now described in detail with respect to FIG. 3. As previously described, the CBR command may be issued to the memory device to perform a refresh of the memory cells in a row of the memory bank 220.

When the CBR command is received by the command decoder 302, the command decoder 302 may send a command to the refresh circuit 310 to perform a refresh of a row of memory cells controlled by a wordline 328 in the memory bank 220.

In some cases, the address counter 314 may be used by the refresh circuit 310 to automatically select which wordline 328 to activate. The address counter 314 may be reset when power is initially applied to the memory device 200 or, in some cases, by issuing a command to the memory device 200. Each time a CBR command is issued to the memory device 200, the address counter 314 may be incremented. In one embodiment, the address counter 314 may be incremented before the refresh is performed. In another embodiment, the address counter 314 may be incremented after the refresh is performed.

Thus, a series of CBR commands issued to the memory device may be used to refresh each row of memory cells in the memory device 200, one wordline 328 at a time. In some cases, when the address counter 314 has cycled through each of the wordlines 328, the counter 314 may loop back to the first wordline.

In performing the CBR refresh, the refresh circuit 310 may trigger an all bank activate command (ACT) followed by an all bank precharge command (PREA). As described above, the ACT command may be issued to activate a row of memory cells in the memory bank 220 by driving the wordline voltage V_{WL} to a high voltage (e.g., V_{PP}). In one embodiment, a wordline driver 326 selected by the row decoder 322 using the address provided by the address counter 314 may be used to apply V_{PP} to the appropriate wordline 328.

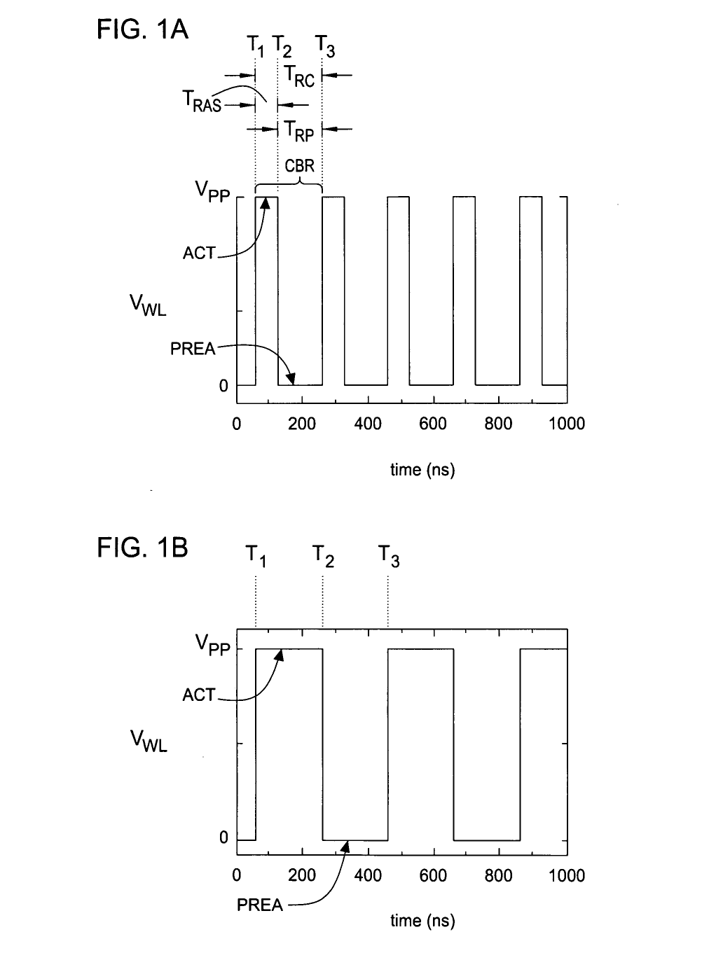

As described above with respect to FIG. 1A, the ACT command may cause the wordline 328 to remain activated for time T_{RAS}. When the CBR command is received and the ACT command is issued, the refresh timer 312 may be started. The refresh timer 312 may be used to ensure that the wordline 328 being refreshed is activated for the time T_{RAS}. In some cases, activating the wordline 328 for time T_{RAS} may be necessary to fully perform the refresh operation for the memory cells controlled by the selected wordline 328.

After time T_{RAS}, the refresh timer 312 may issue a signal terminating the ACT command and triggering the all bank precharge command, PREA. When the PREA command is triggered, each wordline 328 in each of the memory banks 220 may be lowered to a low voltage (e.g., 0 volts), thus electrically disconnecting the bitlines 330 from the memory cells in the memory banks 220.

When the bitlines 330 are disconnected from the memory cells, the PREA command may cause the bitlines 330 to be driven to a voltage which is midway between the voltage corresponding to a bitline high logic level (V_{BLH}) and the voltage corresponding to a bitline low logic level (V_{BLL}), such as (V_{BLH}+V_{BLL})/2). By precharging the bitlines 330 to an intermediate voltage, during a subsequent operation when the values stored in the memory cells are sensed using the bitlines 330, a smaller voltage swing may be necessary to drive the bitlines 330 to the voltage corresponding to the stored logic value (e.g., V_{BLH} for a stored high logic level or V_{BLL} for a stored low logic level) and thereby sense the value stored in the memory cells.

In some cases, the PREA command triggered by the CBR command may automatically terminate after the time T_{RP} (depicted in FIG. 1A) necessary to fully precharge each of the bitlines 330 in the memory banks 220. In one embodiment, T_{RP} is less than T_{RAS}. In other cases, the PREA command may be terminated when another command (e.g., a read, write, or refresh command) is received by the memory device 200.

As described previously, the minimum time typically used to issue a CBR command is the read cycle time T_{RC} (T_{RAS}+T_{RP}). Because the wordline transistors may be stressed while the ACT command is issued to the wordlines (during time T_{RAS}) but not when the PREA command is issued, the duty cycle for a series of CBR commands (T_{RAS}/T_{RC}) may be lower than otherwise desired for testing of the memory device 200. Similarly, as described above with respect to FIG. 1B, issuing a series of separate ACT and PREA commands may not, in some cases, produce a duty cycle which is sufficiently high.

### The Inverted CBR Command

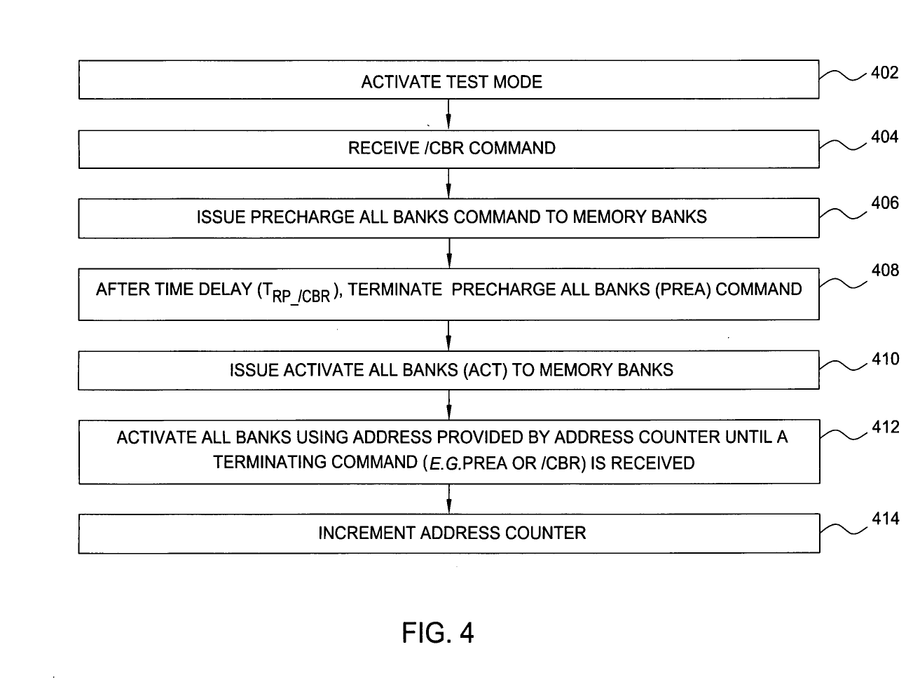

As described above, according to one embodiment of the invention, the duty cycle applied to wordlines 328 in the memory device 200 may be increased with what may be referred to as an inverted refresh command, (or /CBR command). FIG. 4 depicts a process 400 for increasing the duty cycle applied to wordlines 328 in the memory device 200 using the /CBR command according to one embodiment of the invention.

In one embodiment, the process 400 may begin at step 402 where the memory device 200 is placed in a test mode. In one embodiment, the memory device 200 may be placed in a test mode by applying a voltage to an external pin of the memory device 200 or by setting a bit in a control register (e.g., a mode register) of the memory device 200. Optionally, the /CBR command may be issued without placing the memory device 200 in a test mode.

At step 404, a /CBR command may be received. In one embodiment, the /CBR command may be issued to the memory device 200 in the same manner as a CBR command (e.g., by lowering the /CAS command input and subsequently lowering the /RAS command input), but the memory device 200 may instead execute the /CBR command if the memory device 200 is in the test mode when /CAS and /RAS are received. Optionally, other command inputs may be used to issue the CBR command to the memory device.

After the /CBR command is received at step 404, a precharge all banks command (PREA) may be triggered and issued to the memory banks 220 of the memory device 200 at step 406. When the PREA command is issued to the memory banks 220, each of the bitlines 330 may be precharged as described above.

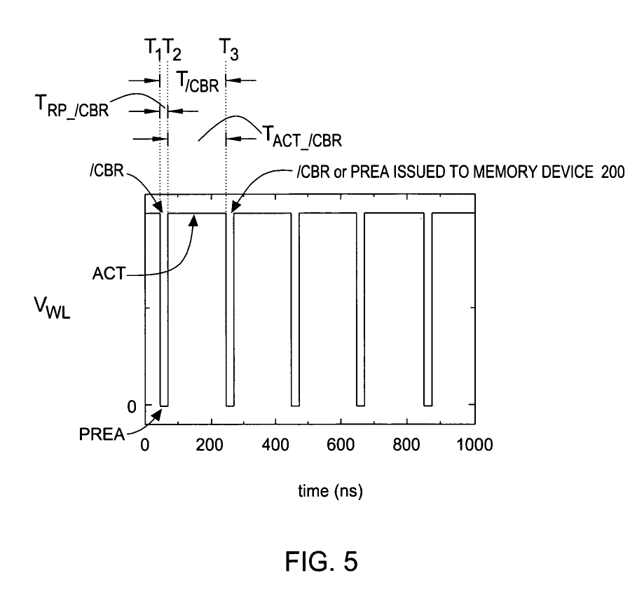

In one embodiment of the invention, the PREA command may be issued for a defined time period (referred to herein as T_{RP}_{_{—}}_{/CBR}) before the PREA command is terminated at step 408. According to one embodiment of the invention, a timer, such as refresh timer 312, may be used to time and automatically terminate the PREA command. In one embodiment, the time T_{RP}_{_{—}}_{/CBR} after which the PREA command terminates may be less than T_{RAS} (as shown in FIG. 5). Similarly, in one embodiment, T_{RP}_{_{—}}_{/CBR} may be less than the time T_{RP} (used during a regular CBR command). In some cases, the specification for the /CBR command may specify a value for T_{RP}_{_{—}}_{/CBR}. Optionally, T_{RP}_{_{—}}_{/CBR} may be selected during testing, for example, by using the testing device 250 to write a value corresponding to T_{RP}_{_{—}}_{/CBR} to a control register of the memory device 200.

At step 410, an activate all banks (ACT) command may be issued to the banks 220 of the memory device 200. In one embodiment, an address provided by the address counter 314 may be used to activate a wordline 328 in the banks 220. When each of the wordlines 328 are activated, a high voltage (V_{PP}) may be applied to the access transistors in those wordlines 328. When the high voltage is applied to the wordlines 328, the wordline circuits may be stressed as described above.

In one embodiment of the invention, the ACT command may not automatically terminate, and thus, the selected wordline(s) 328 may remain activated. Accordingly, in one embodiment, the refresh timer 312 (or T_{RAS} timer) is not used to terminate the ACT command triggered by the /CBR command. Thus, the activate all banks command may be issued and the memory banks 220 may remain activated (and therefore stressed) until another command (a terminating command, e.g., PREA or another /CBR command) is received at step 412, thereby terminating the ACT command as well as the /CBR command.

After the ACT and /CBR commands are terminated, the address counter 314 may be incremented at step 414. As previously mentioned, the address counter 314 may optionally be incremented when the /CBR command is received and before the ACT command is issued. As described below, in one embodiment, the process of receiving /CBR commands and incrementing the address counter 314 may be repeated while the memory device 200 is in the test mode (e.g., during a built-in self-test, BIST).

FIG. 5 is a timing diagram depicting a series of CBR commands issued to the memory device 200 according to one embodiment of the invention.

As depicted, a /CBR command may be received at time T₁, thereby triggering a PREA command. When the PREA command is issued to the memory banks 220, the wordline voltage V_{WL} in each of the memory banks 220 (as well as the bitline voltages ) may be lowered to a low voltage (e.g., 0 volts).

After time T_{RP}_{_{—}}_{/CBR} has expired (at time T₂), the PREA command may be automatically terminated, e.g., by the refresh timer 312. When the PREA command is automatically terminated, the /CBR command may cause the ACT command to be issued to the memory banks 220. When the ACT command is issued to the memory banks 220, the wordline voltage V_{WL} for the wordlines 328 selected by the address counter 314 may be raised to a high voltage (e.g., V_{PP}) as described above.

As depicted, the ACT command may be issued until time T₃ when another command such as a PREA or /CBR command is issued to the memory device 200. Thus, the wordlines 328 may remain activated and stressed for a longer period of time (until another command is received, after time T_{ACT}_{_{—}}_{/CBR}, for example), such that the duty cycle of a single /CBR command (T_{ACT}_{_{—}}_{/CBR}/T_{/CBR}) is greater than the duty cycle for an ordinary CBR command (T_{RAS}/T_{RC}). For example, according to one embodiment of the invention, the /CBR command may result in a duty cycle of over 90%.

By precharging the memory banks 220 before activating the memory banks 220 and maintaining the selected wordline(s) 328 in an active state until another command is received, the /CBR command may be used to greatly increase the stress duty cycle applied to the memory device 200 (e.g., the stress applied to the wordline drivers 326, sense amps, access transistors, and other portions of the memory device 200 affected by the ACT command). As a result, the time required for burn-in may be greatly reduced. Therefore, in some cases, an equivalent amount of stress testing may be performed on the memory device 200 in a shorter period of time by issuing /CBR commands rather than by issuing conventional CBR commands.

### Further Exemplary Embodiments

In one embodiment of the invention, a voltage other than VPP may be applied to the wordlines 328 when the memory device 200 is tested. For instance, in some cases, a higher voltage may be applied to the wordlines 328 to increase the stress places on the memory device 200.

In some embodiments, different methods may be used to terminate a CBR command. As described above, in one embodiment, the ACT command triggered by /CBR (and thus the inverted refresh command /CBR itself) may be terminated by issuing another inverted refresh command /CBR. Optionally, the ACT command triggered by /CBR (and thus the inverted refresh command /CBR) may be terminated by issuing an all banks precharge PREA command. In yet another embodiment, a special command, or optionally, any other command, may be used to terminate the /CBR command. Also, in some cases, the /CBR command may be terminated by deactivating the test mode.

In another embodiment, the activate command issued by the /CBR command may be automatically terminated. For example, in some cases, the ACT command triggered by the /CBR command may be terminated after T_{RAS}. In other cases, the ACT command may be automatically terminated after an extended period (longer than T_{RAS}) provided for by the /CBR command specification. In yet another case, an option may be provided which allows another device (e.g., testing device 250) to select the termination time for and ACT command which is triggered by /CBR. The selected time may be chosen, for instance, by writing a value to a mode register of the memory device 200.

In some cases, the /CBR command may be issued using the command and/or address inputs of the memory device 200. In some cases, the /CBR command may be issued by using a direct connection to the memory device 200 (e.g., via a testing device 250 which utilizes a probe card) via a direct connection to the memory device 200 before the memory device has been separated from the wafer on which it is manufactured. In addition, in some cases, the /CBR command may only be available for use when the memory device 200 is placed in a testing mode. Also, the /CBR command and/or testing mode may only be available while the memory is in a testing configuration as opposed to an operational configuration. The testing configuration may be available when the memory device 200 is manufactured, but the testing configuration may be disabled (e.g., by blowing a fuse, such as an electronically programmable e-fuse, on the memory device 200) after the memory device 200 has been tested.

For some embodiments, the /CBR command may be utilized by the memory device 200 during a built-in self test (BIST). Thus, in one embodiment, the memory device 200 may have BIST circuitry used to perform a self-test of the memory device 200. In some cases, the BIST circuitry may initiate a BIST when the memory device 200 is power on, when the memory device 200 is reset, when a BIST command is issued to the memory device 200, or when a flag is set in a mode register of the memory device 200.

When a BIST is initiated, the BIST circuitry may issue a series of /CBR commands to the memory device 200 in order to perform a stress test. In one embodiment, the BIST circuitry may reset the address counter 314 and issue /CBR commands until each wordline 328 in the memory device 200 has been stressed for a sufficient amount of time. After the /CBR commands are issued, further tests may be performed to ensure that the memory device 200 properly passed the self test.

While described above with respect to a single memory bank accessed by a row decoder and a column decoder, as recognized by those skilled in the art, embodiments of the invention may be adapted for use with any acceptable memory device having memory in any acceptable configuration.

While the foregoing is directed to embodiments of the present invention, other and further embodiments of the invention may be devised without departing from the basic scope thereof, and the scope thereof is determined by the claims that follow.

What is claimed is:

1. A method of operating a memory device, comprising:
receiving an inverted refresh command;
issuing an all bank precharge command in response to receiving the inverted refresh command;
after issuing the all bank precharge command, issuing an all bank activate command, causing wordlines identified by a row address counter to be activated; and
maintaining the identified wordlines in an activated state until a subsequent inverted refresh command is received.

2. The method of claim 1, wherein the all bank precharge command is terminated with a timer of the memory device.

3. The method of claim 1, wherein the all bank precharge command is terminated after a time which is less than a precharge time for a non-inverted refresh command.

4. The method of claim 1, wherein the all bank activate command is terminated without a timer of the memory device.

5. The method of claim 1, wherein the identified wordlines are maintained in the activated state for a period which is greater than a row access time (T_{RAS}) used by a non-inverted refresh command, wherein the row access time is measured by a row access timer of the memory device.

6. A memory device comprising:
one or more memory banks, wherein each memory bank comprises one or more wordlines;
memory bank control circuitry;
a row address counter; and
control circuitry configured to:
receive an inverted refresh command;
issue an all bank precharge command to the memory bank control circuitry in response to receiving the inverted refresh command; and
after issuing the all bank precharge command, issue an all bank activate command to the memory bank control circuitry, causing wordlines identified by the row address counter to be activated, wherein the memory bank control circuitry maintains the identified wordlines in an activated state until a subsequent inverted refresh command is received.

7. The memory device of claim 6, wherein the memory device further comprises a timer, and wherein the all bank precharge command is terminated with the timer of the memory device.

8. The memory device of claim 6, wherein the all bank precharge command is terminated after a time which is less than a precharge time for a non-inverted refresh command.

9. The memory device of claim 6, wherein the all bank activate command is terminated without a timer of the memory device.

10. The memory device of claim 6, wherein the memory device further comprises a row access timer for measuring a row access time (T_{RAS}), and wherein the identified wordlines are maintained by the memory bank control circuitry in the activated state for a period which is greater than the row access time.

11. The memory device of claim 6, wherein the memory device further comprises built-in self-test circuitry configured to issue inverted refresh commands to the memory device when the memory device is placed in a test mode.

12. A memory device comprising:
means for storing, comprising one or more wordlines;
means for addressing; and
means for controlling configured to:
receive an inverted refresh command;
issue a precharge command to the means for storing in response to receiving the inverted refresh command; and
after issuing the precharge command, issue an activate command to the means for storing, causing wordlines identified by means for addressing to be activated, wherein the identified wordlines are maintained in an activated state until a subsequent inverted refresh command is received.

13. The memory device of claim 12, wherein the memory device further comprises a means for timing, and wherein the precharge command is terminated with the means for timing.

14. The memory device of claim 12, wherein the precharge command is terminated after a time which is less than a precharge time for a non-inverted refresh command.

15. The memory device of claim 12, wherein the activate command is terminated without a means for timing of the memory device.

16. The memory device of claim 12, wherein the memory device further comprises a means for timing row accesses for measuring a row access time (T_{RAS}), and wherein the identified wordlines are maintained in the activated state for a period which is greater than the row access time.

17. A system comprising:
a tester configured to issue a plurality of inverted refresh commands; and
a memory device configured to receive the plurality of inverted refresh commands from the tester, and, in response to receiving each of the plurality of inverted refresh commands:
issue an all bank precharge command;
after issuing the all bank precharge command, issue an all bank activate command causing wordlines identified by a row address counter to be activated and maintained in an activated state until a subsequent inverted refresh command is received from the tester; and
increment the row address counter.

18. The system of claim 17, wherein the memory device further comprises a timer, and wherein the all bank precharge command is automatically terminated with the timer.

19. The system of claim 17, wherein the all bank precharge command is terminated after a time which is less than a precharge time for a non-inverted refresh command received by the memory device.

20. The system of claim 17, wherein all bank activate command is terminated without a timer of the memory device.

21. The system of claim 17, wherein the memory device further comprises a row access timer for measuring a row access time (T_{RAS}), and wherein the identified wordlines are maintained by the memory bank control circuitry in the activated state for a period which is greater than the row access time.

22. A method for testing a memory device, the method comprising:
sending a first inverted refresh command to the memory device, wherein, in response to receiving the inverted refresh command, the memory device triggers a first all bank precharge command, wherein the all bank precharge command is automatically terminated by a first all bank activate also triggered by the memory device; and
sending a second inverted refresh command to the memory device, wherein the second inverted refresh command triggers a second all bank precharge command, wherein the second all bank precharge command deactivates one or more wordlines in the memory device activated by the first all bank activate command.

23. The method of claim 1, further comprising:
sending an external all bank precharge command to the memory device, wherein the external all bank precharge command deactivates one or more wordlines in the memory device activated by the second inverted refresh command.

24. The method of claim 1, wherein the first all bank precharge command is automatically terminated with a timer of the memory device.

25. The method of claim 1, wherein the first all bank precharge command is terminated after a time which is less than a precharge time for a non-inverted refresh command sent to the memory device.

26. The method of claim 1, wherein the first all bank activate command is terminated without a timer of the memory device.
